(19) United States
(12) Patent Application Publication
(10) Pub. No.: US 2010/0249306 A1
(43) Pub. Date: Sep. 30, 2010

(54) HYDROPHOBIC SURFACE COATING FOR ELECTRONIC AND ELECTRO-TECHNICAL COMPONENTS AND USES THEREOF

(76) Inventors: Anett Berndt, Erlangen (DE); Rudolf Gensler, Singapore (SG); Heinrich Kapitza, Furth (DE); Heinrich Zeininger, Obermichelbach (DE)

Correspondence Address: King & Spalding LLP, 401 Congress Avenue, Suite 3200, Austin, TX, 78701, US

(21) Appl. No.: 12/601,172

(22) PCT Filed: May 19, 2008
(86) PCT No.: PCT/EP2008/056108

§ 371 Date: May 25, 2010

(30) Foreign Application Priority Data
May 21, 2007 (DE) 10 2007 023 555.2

(51) Int. Cl. C08K 3/38; C08K 3/36; C08L 55/00

(52) U.S. Cl. 524/404; 524/492; 524/566

(57) ABSTRACT

A hydrophobic surface coating, in particular for electronic and electrotechnical components, can be produced easily and inexpensively. For this purpose, particles and micro powders, hydrophobic particles in particular, are incorporated into the protective lacquer.

### CROSS-REFERENCE TO RELATED APPLICATIONS

This application is a U.S. National Stage Application of International Application No. PCT/EP2008/056108 filed May 19, 2008, which designates the United States of America, and claims priority to German Application No. 10 2007 023 555.2 filed May 21, 2007, the contents of which are hereby incorporated by reference in their entirety.

### TECHNICAL FIELD

The invention relates to a hydrophobic surface coating, in particular for electronic and electro-technical components, which can be produced easily and inexpensively.

### BACKGROUND

Conventional protective lacquers for electronic and/or electro-technical components, like for instance electronic printed circuit boards, isolators and components in the field of railway electrification and energy transmission based on alkyd, epoxide, polyurethane (PU) and/or silicon materials for instance, show relatively high surface energies with the exception of silicon lacquer. The contact angles relative to water are generally <80°, silicon lacquers achieve approximately 110°. The majority of lacquer surfaces are therefore easily moistened with water.

When uncoated components and components coated with alkyd/epoxides etc are used in damp environments, the electrical contacts can be conductively connected by spreading surface-moistening water condensates, thereby frequently resulting in components failing as a result of the formation of creepage currents. Conventional lacquers, including silicon lacquers, absorb water during water storage. Microcracks in the lacquer enable the moisture to penetrate correspondingly deeply and to create a conductive connection. In the process, salt and impurities increase the conductivity and thus the risk of an electrolytic corrosion of electro-technical components such as for instance conductors and/or plug contacts.

Fluorine-based coverings (e.g. Teflon AF by DuPont, EGC1700 by 3M) exist, which are hydrophobic but, in the case of water storage, show a clear decrease in the contact angle, in other words also the hydrophoby. Furthermore, they do not exhibit adequate adhesion to the substrate and/or their mechanical resistance is low.

Hydrophobic additives, for instance wax, water-repellent SiO₂ powder and/or various aerosol types, the homogenous incorporation of which into the lacquer is difficult, also exist.

### SUMMARY

According to various embodiments, a hydrophobic surface coating can be created, which makes the moistening of the lacquer with water condensates difficult.

According to an embodiment, a protective lacquer is based on duroplastic plastic, into which micro powders, nanoparticles and/or colloids, which have hydrophobically functional groups, depending on their type, can be incorporated.

According to a further embodiment bornitride may be incorporated as micropowder. According to a further embodiment, silicum dioxide (SiO₂) may be incorporated in the form of nanoparticles and/or colloids. According to a further embodiment, SiO₂ particles can be incorporated in the form of prefabricated sols and/or colloids. According to a further embodiment, the micropowder, the nanoparticles or the colloids can be incorporated in a quantity of 0.5 to 50% by weight. According to a further embodiment, bornitride micropowder can be incorporated in a quantity between 5 and 60% by weight. According to a further embodiment, hydrophobic silicum dioxide nanoparticles can be incorporated in a quantity of 1 to 10% by weight. According to a further embodiment, hydrophobic silicum dioxide nanoparticles can be incorporated in a quantity of 1 to 10% by weight.

According to another embodiment, a protective lacquer as described above can be used for coating metals and/or for protection in aqueous media of electronic modules, capacitors, sensors and/or machines for the electronic production and/or assembly.

According to yet another embodiment, a protective lacquer as described above can be used for protective lacquering of electronic printed circuit boards.

According to yet another embodiment, a protective lacquer as described above can be used for assembled electronic printed circuit boards and/or sensor coatings for external and internal applications.

### DETAILED DESCRIPTION

According to various embodiments in a protective lacquer based on duroplastic plastics, nanoparticles and/or colloids are incorporated into the micro powder, which, depending on their nature, have hydrophobically functional groups.

Protective lacquers based on duroplastic plastics are for instance acrylic resins, in particular isocyanate-moistened polyacryl resin, polyurethane lacquer such as for instance FreiLacke EF-DEDUR UR 1040 (Emil Frei GmbH & Co) and/or clear lacquer by Bayer Ag, like for instance the product RR4821 (Bayer AG).

Suitable micro powders, nanoparticles and/or colloids are used in the form of prefabricated sols for instance. The micro powder and/or the nanoparticles and/or colloids preferably include SiO₂ particles and/or bornitride particles and are characterised by easy incorporability, stability in the lacquer matrix and if necessary in sol-gel systems.

Hydrophobic functionalization naturally only works with functionalizable particles and micro powders, for instance SiO₂ particles and can take place across all current hydrophobic groups, for instance, the following functionalities can be provided on SiO₂ particles: methyl-, octyl-, phenyl-, fluoralkyl-, like for instance SiC₂H₅CₙF₂ₙ₊₁ with n=1-8.

The incorporation of hydrophobically functionalized SiO₂ nanoparticles/colloids and/or bornitride particles in the form of prefabricated particle sols and/or micropowders into duroplastic lacquer matrices allows hydrophobic lacquer surfaces with low surface energies to be obtained.

In polyurethane systems (PU), the contact angle relative to water of approximately 80° to >120° can be increased.

The SiO₂ nanoparticles and/or colloids are used in the form of prefabricated sols for instance. These are customary for instance and products from FEW Chemicals, Wolfen, Germany, like for instance H4019, are used.

The formulation of an exemplary embodiment is as follows:

50 g of a solvent-containing 2 K polyurethane lacquer (isocyanate-moistened polyacryl resin) is (depending on the application) diluted with up to 200 g butyl acetate and stirred for 5 minutes. Subsequently, 1-1.5 g of the hydrophobically functionalised SiO₂ additives (H4019) is added and stirred for a further 15 minutes. This mixture is used to coat samples by immersion and/or spraying. The samples are dried for 5 hours at RT. The lacquer hardens after approximately 48 h/RT or after 2 hours at 80° C.

The finished lacquer mixture can be processed at room temperature for approximately 6 hours (working life). The contact angle relative to water could be increased to above 110° compared with unmodified PU (with a contact angle <85). The layer thickness of the protective lacquer layer can be adjusted between 200 nm and 500 μm depending on the lacquer dilution/processing.

In addition or alternatively to the hydrophobically functionalized SiO₂ particles, the hydrophoby in the PU or silicon lacquers could also be increased by incorporating bornitride (BN) micro powder. With increasing BN concentration, the hydrophoby of the lacquer surfaces increases. By way of example, reference is made to a polyurethane protective lacquer, which without additives, has a contact angle of 83°, while with an addition of 10% bornitride by weight, a contact angle of 105° is achieved.

In the case of silicon lacquer, a check was similarly carried out to determine where a pure silicon lacquer (Powersil by Wacker A G) has a contact angle of 95° (glass) and/or 105° (steel) and an additional 10% of bornitride results in a contact angle of 122°. These values could even be increased again since an addition of 20% by weight of bornitride resulted in a contact angle of 130° and an addition of 30% by weight of bornitride effected a contact angle of 135°.

Bornitride micro powder can be incorporated into the protective lacquer in quantities of 5 to 60% by weight, preferably in quantities between 5 and 50% by weight, in particular preferably in quantities between 10 and 15% by weight, as the exemplary embodiments document

The invention is further described in more detail below with reference to selected exemplary embodiments.

The PU lacquers are essentially well suited to external applications and coatings in liquid medium as a result of the high weather-resistance.

### Example 1

Coating of metals/protection in aqueous media of electronic modules, capacitors, sensors, engineering for the electronic production/equipment (reflow oven, . . . ).

Lacquer composition: 3.4 g desmophen 670 (Bayer A G: formulation RR4821 or FreiLacke: EFDEDUR) 1.8 g desmodur N3390 (Bayer), 20 g butyl acetate and 0.3 g H4019 (FEW Chemicals). Metal substrates were taken as carriers.

The long term stability of the hydrophobic surface effect was proven with coated metal disks (layer thickness <1 μm): After a storage time in water of 1000 hours, the contact angle of approximately 110° only reduces to values >90°—the surface therefore remains hydrophobic. In comparison: the contact angle of conventional PU lacquers is approximately 85° and drops to approximately 70° during storage.

### Example 2

### Protective Lacquering of Electronic Printed Circuit Boards

SiO₂-modified PU lacquers could be used particularly advantageously in radio modules, for instance in RF modules, since only very thin protective lacquer thicknesses of <200 nm are essentially applied there in order to prevent interference. The protective lacquers according to various embodiments nevertheless already provide complete protection in these layer thicknesses.

The same applies to sensor systems in the automotive industry, for instance with radar sensors.

### Example 3

### Electronic Printed Circuit Board and/or Sensor Coatings for External and Internal Applications, for Instance in the Automotive Industry: Acoustic Wave Sensor

Lacquer composition: 3.4 g desmophen 670, 1.8 g desmodur N3390 (Bayer), 45 g butyl acetate and 0.3 g H4019 (FEW Chemicals).

For instance, electronic printed circuit boards for automotive applications were covered with a defined design, e.g. HF modules or sensors with the protective lacquer according to various embodiments.

These modules only pass the required condensation tests according to IEC 60068-2-38 and/or IEC 60068-2-78 with the SIO2-modified PU coatings. After coating the electronic modules (layer thickness 170 nm), the contact angle of an coating according to various embodiments is 110°.

The coated sensors (AWS, Simaf) according to various embodiments also show significantly improved values in respect of the prior art.

The invention has a series of advantages compared with the prior art:

On the one hand, very high contact angles are realised, the contact angle of the protective lacquer according to various embodiments generally lies above 110° relative to water, although the invention can in some instances naturally also include protective lacquers with a smaller contact angle.

Secondly, the method involves inexpensive variant for producing the protective lacquer, since only small quantities, for instance 1 to 10% by weight, preferably 3 to 7% by weight and particularly preferably up to 5% by weight of hydrophobic SiO₂ nanoparticles are needed.

The water-repellent nanoparticles can be incorporated into the lacquer components by simply mixing. Special mixing apparatuses, e.g. bead mills, torus mills etc. are not needed. The distribution of the nanoparticles in the lacquer is very homogenous, since the particles are incorporated as stable sols.

The systems according to various embodiments are hugely advantageous in that the high contact angle of the BN-filled PU and silicon systems are also retained at higher temperatures. The application area, in particular the PU

ATTORNEY DOCKET PATENT APPLICATION lacquer, is therefore significantly widened. With the hydrophobic PU lacquers according to various embodiments, the application areas with operating temperatures of previously approximately 120-225° C. are considered for applications in the automotive industry with operating temperatures of 150 to 160° C.

With BN doped silicon lacquers, the high contact angle is retained at temperatures of above 200° C.

The protective lacquers according to various embodiments pass all the required creepage current tests CTI 600.

Furthermore, the protective lacquers according to various embodiments adhere well, for instance on fiber composites, plastics, aluminium, steel and similar substrates.

The protective lacquer can therefore also be applied in extremely thin layer thickness and dispense with full effect, the protective lacquer can already be fully effective in a layer thickness ranging between 130 and 250 nm for instance.

The invention relates to a hydrophobic surface coating, in particular for electronic and electro-technical components, which can be produced easily and inexpensively. To this end, particles and micro powders, in particular hydrophobic particles, are incorporated into the protective lacquer.

What is claimed is:

1. A protective lacquer based on duroplastic plastic into which at least one of micro powders, nanoparticles and colloids, which have hydrophobically functional groups depending on their type, are incorporated.

2. The protective lacquer according to claim 1, wherein bornitride is incorporated as micropowder.

3. The protective lacquer according to claim 1, wherein silicum dioxide (SiO₂) is incorporated in the form of at least one of nanoparticles and colloids.

4. The protective lacquer according to claim 1, wherein SiO₂ particles being incorporated in the form of at least one of prefabricated sols and colloids.

5. The protective lacquer according to claim 1, wherein the micropowder, the nanoparticles or the colloids are incorporated in a quantity of 0.5 to 50% by weight.

6. The protective lacquer according to claim 1, wherein bornitride micropowder is incorporated in a quantity between 5 and 60% by weight.

7. The protective lacquer according to claim 1, wherein hydrophobic silicum dioxide nanoparticles are incorporated in a quantity of 1 to 10% by weight.

8. The protective lacquer according to claim 1, wherein hydrophobic silicum dioxide nanoparticles are incorporated in a quantity of 1 to 10% by weight.

9. A method for using a protective lacquer according to claim 1, comprising the step of using said protective lacquer to perform at least one of coat metals and to protect at least one of electronic modules, capacitors, sensors, and machines for the electronic production and/or assembly in aqueous media.

10. The method for using protective lacquer according to claim 1, comprising the step of using said protective lacquer for protective lacquering of electronic printed circuit boards.

11. A method for using a protective lacquer according to claim 1, comprising the step of using said protective lacquer for at least one of assembled electronic printed circuit boards and sensor coatings for external and internal applications.

12. The method according to claim 9, wherein bornitride is incorporated as micropowder.

13. The method according to claim 9, wherein silicum dioxide (SiO₂) is incorporated in the form of at least one of nanoparticles and colloids.

14. The method according to claim 9, wherein SiO₂ particles are incorporated in the form of at least one of prefabricated sols and colloids.

16. The method according to claim 9, wherein the micropowder, the nanoparticles or the colloids are incorporated in a quantity of 0.5 to 50% by weight.

17. The method according to claim 9, wherein bornitride micropowder is incorporated in a quantity between 5 and 60% by weight.

18. The method according to claim 9, wherein hydrophobic silicum dioxide nanoparticles are incorporated in a quantity of 1 to 10% by weight.

19. The method according to claim 9, wherein hydrophobic silicum dioxide nanoparticles are incorporated in a quantity of 1 to 10% by weight.
